(19) United States
(12) Patent Application Publication
(10) Pub. No.: US 2009/0189901 A1
(43) Pub. Date: Jul. 30, 2009

(54) COORDINATE SYSTEM IDENTIFICATION

(75) Inventors: Philippe Robert Steinthal, Houston, TX (US); Richard Lee Thompson, Houston, TX (US)

Correspondence Address: SCHLUMBERGER INFORMATION SOLUTIONS, 5599 SAN FELIPE, SUITE 1700, HOUSTON, TX, 77056-2722, US

(73) Assignee: Schlumberger Technology Corporation, Sugar Land, TX (US)

(21) Appl. No.: 12/356,840

(22) Filed: Jan. 21, 2009

Related U.S. Application Data
(60) Provisional application No. 61/024,675, filed on Jan. 30, 2008.

(51) Int. Cl. G06T 11/20

(52) U.S. Cl. 345/441

(57) ABSTRACT

An example method for coordinate system identification that includes obtaining an attribute and a spatial entity of a region and identifying a number of information repositories using a business rule, the business rule identified using the attribute. The method further includes accessing the number of information repositories to identify a number of coordinate systems, each of the number of coordinate systems defined for the spatial entity. The method further includes selecting one of the number of coordinate systems, transforming spatial data for the region based on the one of the number of coordinate systems to generate a map, and displaying the map including the spatial data.

### CROSS-REFERENCE TO RELATED APPLICATION

This application claims priority, pursuant to 35 U.S.C. §119(e), to the filing date of U.S. Patent Application Ser. No. 61/024,675, entitled “Method and System for Coordinate System Identification,” filed on Jan. 30, 2008, which is hereby incorporated by reference in its entirety. In addition, the subject matter described in this application may be related to patent application Ser. No. 11/854,436 filed Sep. 12, 2007.

### BACKGROUND

Cartography is the design and production of maps, or visual representations of spatial data. In cartography, coordinate systems are used as references for locations on the Earth and/or on planar maps. For any given location on the Earth and for a given map display and scale, one or many of the more than 300 geographic coordinate systems and more than 2500 projected coordinate systems are available for use. A geographic coordinate system specifies a location on the Earth using three coordinates of a spherical coordinate system aligned with an axis of the Earth.

A projection is a two-dimensional representation of a three-dimensional area, and a projection may be implemented using any of the projected coordinate systems. The projected coordinate system defines one or more mathematical functions to translate the three-dimensional representation to a two-dimensional representation. For instance, a projection may be used to represent the Earth, a three-dimensional object, as a planar surface, such as a map. Furthermore, flat maps require the use of map projections. Flat maps may be more useful than globes or other three-dimensional representations in many situations: they are more compact and easier to store; they readily accommodate a wide range of scales; and they are viewed easily on computer displays.

Many properties of the Earth's surface may be measured independent of its geography. For instance, some properties of interest may be area, shape, direction, distance, and scale. Map projections may be constructed to preserve one or more of these properties, though not all of them simultaneously. Each projected coordinate system and the resulting map projection, preserves, compromises, or approximates the basic properties in different ways. The purpose of the map, then, determines which projected coordinate system should be utilized to generate the map projection.

A geographic information system (GIS) is a system for capturing, storing, analyzing, and managing data and associated attributes, which are spatially referenced to the earth. More generically, a GIS is a tool (e.g., a computer system) that allows users to interact with geographically-referenced information. GIS software has widespread applicability and is often used throughout science, government, business, and industry, with applications including real estate, public health, crime mapping, national defense, sustainable development, natural resources, transportation, and logistics. Furthermore, GIS software is especially pertinent to energy exploration and drilling companies. Energy companies may use a GIS along with geographic data to locate and explore potential drilling regions or to control operations in current oil or gas fields. Such companies demand accurate and consistent geographic data, as mistakes can be very costly.

### SUMMARY

An example method for coordinate system identification that includes obtaining an attribute and a spatial entity of a region and identifying a number of information repositories using a business rule, the business rule identified using the attribute. The method further includes accessing the number of information repositories to identify a number of coordinate systems, each of the number of coordinate systems defined for the spatial entity. The method further includes selecting one of the number of coordinate systems, transforming spatial data for the region based on the one of the number of coordinate systems to generate a map, and displaying the map including the spatial data.

Other aspects of coordinate system identification will be apparent from the following description and the appended claims.

### BRIEF DESCRIPTION OF DRAWINGS

FIG. 1 shows a schematic diagram of an example system in which one or more embodiments can be implemented.

FIGS. 2-3 show flowcharts of a method in accordance with one or more embodiments.

FIG. 4 shows a geographic display in accordance with one or more embodiments.

FIG. 5 shows a computer system in accordance with one or more embodiments.

### DETAILED DESCRIPTION

Specific embodiments of coordinate system identification will now be described in detail with reference to the accompanying figures. Like elements in the various figures are denoted by like reference numerals for consistency.

In the following detailed description of embodiments of coordinate system identification, numerous specific details are set forth in order to provide a more thorough understanding of coordinate system identification. However, it will be apparent to one of ordinary skill in the art that embodiments may be practiced without these specific details. In other instances, well-known features have not been described in detail to avoid unnecessarily complicating the description.

In general, one or more embodiments provide a method and system for identifying an appropriate coordinate system. In order to identify the appropriate coordinate system, embodiments of coordinate system identification aggregate information provided by multiple different information repositories. Specifically, one or more embodiments use the information repositories in conjunction with attributes specified by a client to deduce which coordinate system(s) are appropriate for the attributes.

For instance, consider the scenario in which a client desires a map of a region, but the client does not have spatial data for generating the map. Specifically, the client may not have the particular survey data, spatial data (e.g., shape files, spatial database engine (SDE) layers), or any other such data from which a map may be directly generated. In this case, the client may specify attributes about a survey when the client does not know the exact name of the survey. The client may further specify the approximate region of the survey. The attributes and the approximate region may be used in conjunction with multiple information repositories to identify the survey. Further, the appropriate coordinate system may be identified based on the attributes and the survey from the multiple information repositories. From the survey, spatial data may be generated in the appropriate coordinate system to generate the map.

In another instance, the client may have the spatial data for which the client does not know the coordinate system. In this instance, the client may specify attributes about the spatial data and the region of the world represented by the spatial data. Further, multiple information repositories may be accessed to identify the most likely coordinate system for the spatial data given the region and attributes. Embodiments may also determine whether the most likely coordinate system is the most appropriate coordinate system for the use of the client. If the most appropriate coordinate system is different than the most likely coordinate system, then one or more embodiments may transform the spatial data into the most appropriate coordinate system.

In another instance, the client may have a document and not know the coordinate system of coordinates referred to in the document. In this instance, embodiments may analyze the document to obtain attributes relevant to identifying the coordinate system. Embodiments may further access multiple data repositories to identify the coordinate system referred to in the document. Further, a map of a region specified by the coordinates in the document may be generated in the coordinate system.

In one or more embodiments, an attribute is information relevant to the identification of the coordinate system. The attribute may be a property of the region (e.g., a language, number of barrels of hydrocarbons produced, number of miles from a city, a population, weather data, or any statistical data), a name of a physical structure within the region, a company that generates surveys, a technological field, the intended use of the map, a data format of a coordinate system, or any other information relevant to the identification of a coordinate system. For instance, the attribute may be countries that have French as a national language. In another instance, the attribute may be a name of an oilfield, name of a building, name of a mountain, name of an archeological site, etc. Further, for instance, the attribute may specify military operations, oilfield operations, hydrological modeling, or any other technological field. The attribute may also include intended use information such as, but not limited to, displayed for the general public, company presentation, or scientific community. As shown in the above instances, the attribute may be virtually anything that assists in the identification of a coordinate system.

In one or more embodiments, regions are identified by a spatial entity. A spatial entity is an identification of a geographic location within a geographic region. For instance, the spatial entity may be coordinates, a name of a geographic region, or any other identifier of a location.

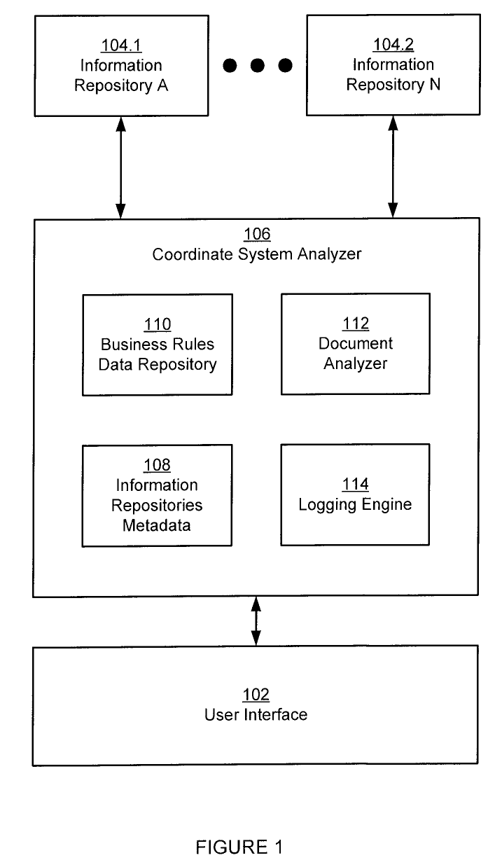

FIG. 1 shows a schematic diagram of a system in accordance with one or more embodiments. As shown in FIG. 1, the system includes a user interface (102), information repositories (e.g., information repository A (104.1), information repository B (104.2)), and a coordinate system analyzer (106). Each of these components is described below.

In one or more embodiments, the user interface (102) is configured to interact with the client (e.g., individual, computer, representative of a company, university, organization, or any other group). Specifically, the user interface (102) includes functionality to guide the client and to display a list of coordinate system from which the client may select a coordinate system. Further, in one or more embodiments, the user interface (102) may also include functionality to generate a map. Those skilled in the art will appreciate that the user interface (102) may be included in a client application (not shown) accessed by the client.

In one or more embodiments, the user interface (102) may be displayed in a single window, as a collection of windows, and/or as a series of tabs. For instance, the user interface (102) may include a portion by which a client may submit a query in a query-based language. In another instance, the user interface (102) may include fields (e.g., text boxes, check boxes, radio buttons, etc.) for obtaining information from the client. Using the user interface (102), the fields or the query, the client may specify attributes, a spatial entity, a document identifier, a project identifier, and/or a geographic or projected coordinate system.

When the user interface (102) includes a collection of fields, each field may be associated with a corresponding attribute. For instance, one field may allow the client to specify a language spoken in the region while another field allows the client to specify the intended use of the map. In one or more embodiments, the fields of the user interface (102) are dependent on the client. For instance, if the client is part of an oil production group, then the user interface (102) may include fields that are directed to identifying coordinate systems for oil fields or potential oil fields. In this instance, the user interface (102) may include a field for specifying the name of the company that generates a survey, while not including fields for locating archeological sites.

The user interface (102) may also allow a client to specify the region using a spatial entity. For instance, the user interface (102) may display a map in a window. The client may specify the spatial entity by selecting a point on the map. The user interface (102) may interpret the point as x and y coordinates with respect to static position on the map, such as a corner of the map (e.g., the corner of the map may have x and y coordinates of (0, 0)). Because the window displays the map, the x and y coordinate specify a geographic location. Alternatively, the client may select the spatial entity by creating a box on the map that surrounds the region. In this case, the client may instead specify the name of a location in a field. The spatial entity may be the name of the location. For instance, the spatial entity may be a city name, country name, longitude and latitude, postal address, etc.

Once the coordinate systems are identified, the user interface (102) may also be used to display a list of identifiers, such as names, of the coordinate systems. The list may be in a ranked order according to how appropriate the coordinate system is with respect to the attributes and spatial entity. Further, in one or more embodiments, the user interface (102) allows the client to select a coordinate system from the list and display a map of the region that is generated in the coordinate system.

Continuing with FIG. 1, in one or more embodiments, information repositories (e.g., information repository A (104.1), information repository B (104.2)) are storage systems, such as Internet and Intranet websites, internal and external databases, and other such repositories of information that may be used to obtain information that assists in the identification of a coordinate system. For instance, information repositories (e.g., information repository A (104.1), information repository B (104.2)) may include internal databases and websites developed by the client. Information repositories (e.g., information repository A (104.1), information repository B (104.2)) may also include external databases and sources of information, such as databases created by third parties, public databases, governmental databases and websites, etc.

The information repositories (e.g., information repository A (104.1), information repository B (104.2)) may include the government census data of a particular nation, the World Factbook published by the Central Intelligence Agency of the United States of America, databases maintained by the International Association of Oil and Gas Producers, metadata associated with surveys, weather statistical databases, company websites that conduct surveys, databases that identify the spatial entity from a name of a particular physical structure, or any other source of information. In one or more embodiments, at least one information repository (e.g., information repository A (104.1), information repository B (104.2)) correlates coordinate systems with particular regions of the world in which each coordinate system is appropriate. The region in which a coordinate system is appropriate may be denoted as a polygon on a global representation of the World (i.e., extent). For instance, the information repository may store coordinates of borders or points of the extent with the coordinate system for the extent.

In one or more embodiments, the coordinate system analyzer (106) is interposed between the information repositories (e.g., information repository A (104.1), information repository B (104.2)) and the user interface (102). In one or more embodiments, the coordinate system analyzer (106) includes functionality to identify a survey and/or to identify the likely coordinate system of spatial data when the spatial data does not have a coordinate system. Specifically, the coordinate system analyzer (106) includes functionality to obtain attributes and spatial entities, access the information repositories (e.g., information repository A (104.1), information repository B (104.2)), and identify the appropriate coordinate systems. The coordinate system analyzer (106) may include information repositories metadata (108), a business rules data repository (110), a document analyzer (112), and a logging engine (114). Each of these components is described below.

In one or more embodiments, information repositories metadata (108) include information regarding how to access information in the information repositories. For instance, the information repositories metadata (108) may include location information (e.g., web address, local address, or other such location information), authentication information, and/or storage information (e.g., how to access the information in the information repository).

In one or more embodiments, the type of data in the information repository metadata (108) is dependant on the type of information repository. For instance, for information repositories corresponding to a database, the information repository metadata (108) may include schemas and templates for generating queries. In another instance, for information repositories corresponding to websites, the information repository metadata (108) may include scripts to access a website and obtain information from the website.

In one or more embodiments, the coordinate system analyzer (106) includes a business rules data repository (110). The business rules data repository (110) includes business rules. Each business rule defines which information repository to access for a given type of attribute or query. Specifically, in one or more embodiments, the business rule may have an input parameter that requires a particular type of attribute (e.g., survey name, language, country name, etc.). For instance, a business rule may specify to access a particular energy company's database for an attribute specifying the name of an oil field. Another business rule may specify to access the census database when an attribute specifies a population or any other type of data that is commonly collected by census.

In one or more embodiments, the business rules are defined by the organization associated with the client. For instance, a representative of the organization may identify types of queries that are performed by the client and/or the organization. Alternatively, or in addition to, business rules may be predefined. For instance, business rules for obtaining information from publicly available institutions may be predefined.

In one or more embodiments, a document analyzer (112) includes functionality to obtain attributes from documents and project metadata. Specifically, the document analyzer (112) includes functionality to parse the document and project metadata and obtain attributes and/or spatial entities from the document and project metadata. For instance, the document analyzer (112) may identify proper names of physical structures, city names, country names, language, name of the technological field, company name, distance from a known location, survey name, property of a location, coordinates, or any other relevant information. The document analyzer (112) may include a common attribute list to identify which words and phrases correspond to attributes. The common attribute list may be maintained in virtually any data structure known in the art.

Continuing with FIG. 1, a logging engine (114) includes functionality to maintain a log. A log may be a list of data used for tracking purposes. The log may track attributes associated with coordinate systems removed from the list of appropriate coordinate systems. Alternatively, or in addition to, the log may track the actions performed by the client, such as modifications to the attributes and/or to the spatial entity.

For instance, consider the scenario in which a client submits attributes “X”, “Y”, and “Z”. Based on the attributes “X”, “Y”, and “Z”, the client may receive and review a list of coordinate systems “List B”. If the desired coordinate system is not in the list, then the client may decide to replace a previously submitted attribute (e.g., “X”) with a different attribute (e.g., “W”). The coordinate system analyzer (106) may return “List C” in response to the replacement. The log may contain the “X”, “Y”, and “Z” with “List B” followed by “W”, “Y”, and “Z” with “List C”. Further, or as an alternative to, the log may identify which coordinate system is included or excluded in “List C” as opposed to “List B” and store the differences with the notation that “X” is removed from the collection of attributes submitted and “W” is added to the collection of attributes submitted. Further, or as an alternative to, the log may contain “X”, “Y”, and “Z” followed by “W”, “Y”, and “Z” to track input from the client. Thus, if the client submits a revised collection of attributes and is not pleased with the modified list of coordinate systems, then the client may revert, using the log, to the previous collection of attributes.

While not shown in FIG. 1, the system or a portion thereof may be directly on a computing device of the client and/or the system or a portion thereof may be located on one or more servers and accessible via a network. For instance, the client may access the system as a local application, connect directly to the system via a website, or connect to the system using a web portal. Alternatively, a portion of the system (e.g., a client-side portion with the user interface) may be located on the client computing device and a portion (e.g., a server-side portion with the coordinate system framework) may be remote. The portion located on the client computing device may include functionality to access the portion that is remotely located.

While specific components are depicted and/or described for use in the units and/or modules of the coordinate system analyzer (106), it will be appreciated that a variety of components with various functions may be used to provide the formatting, processing, utility and coordination functions necessary to provide real-time processing in the coordinate system analyzer (106). The components may have combined functionalities and may be implemented as software, hardware, firmware, or combinations thereof.

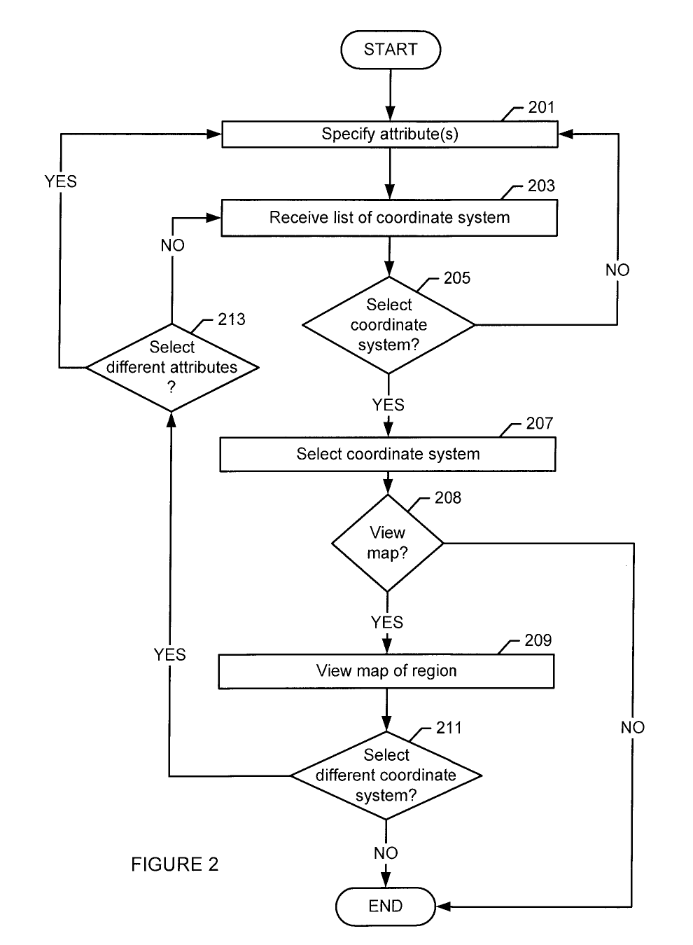

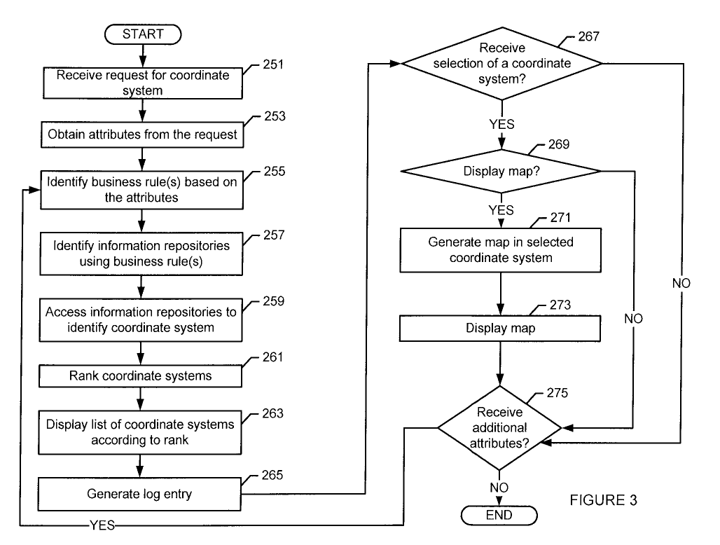

FIGS. 2-3 show flowcharts of a method in accordance with one or more embodiments. While the various portions of this flowchart are presented and described sequentially, one of ordinary skill will appreciate that some or all of the method may be executed in different orders, may be combined or omitted, and some or all of the method may be executed in parallel. In addition, portions of the method have been omitted to simplify the presentation.

FIG. 2 shows a flowchart of method for a client to identify an appropriate coordinate system and/or view a map of a region in an appropriate coordinate system, in accordance with one or more embodiments. As discussed above, various reasons may exist for a client to identify the appropriate coordinate system. For instance, the client may have spatial data and not know the coordinate system of the spatial data. In this instance, the client may have lost a metadata file describing the coordinate system. In another instance, the client may have a document and not know the coordinate system of coordinates referred to in the document. In another instance, the client may desire a map of a particular survey, but not have the name of the survey much less the coordinate system used to generate the survey. In another instance, the client may have a particular use of a map that requires that the appropriate coordinate system.

Accordingly, initially, the client specifies one or more attribute(s) (block 201). For instance, the client may specify one or more attribute(s) by submitting data into a form, a query in a query language, a document name, project metadata, and/or a file name containing spatial data from which attributes may be extracted. The client may specify the attributes by entering the attributes into a form or by using a command based language. When specifying the attributes, the client may additionally submit a spatial entity for the region in which the coordinate system should be defined. In particular, the client may specify a location on a map or create a box around the region in which the client is interested. In one or more embodiments, the spatial coordinate may be an estimate of the region.

For instance, consider the scenario in which the client desires a map of a particular survey. In this instance, the client is aware that the survey included data gathered in a section of the Gulf of Mexico. However, the client may not know where the section is located in the Gulf of Mexico. Thus, the client may create a box on a world map that spans the entirety of the Gulf of Mexico and specify attributes about the survey, such as a date range in which the survey was performed, a name of company performing survey, a type of data gathered in the survey, and/or any other relevant information. The coordinate system may process the attributes to identify appropriate coordinate systems.

Although not shown in FIG. 2, in one or more embodiments, additional input may be requested from the client prior to displaying the list of coordinate systems. The request for additional input may occur, for instance, when the spatial entity is ambiguous (e.g., the client specifies Cambridge) or when the attributes conflict. In such a scenario, the request for additional input may be a dialog box or window that requests the client submit additional information.

In one or more embodiments, the client receives a list of coordinate systems (block 203). In one or more embodiments, the list of coordinate systems is displayed in the user interface. Further, in one or more embodiments, the list of coordinate systems may be ranked according to a likelihood that the coordinate system is appropriate for the attributes and the spatial entity. Accordingly, the client may review the ranking as an indication of which coordinate system is most likely correct.

While reviewing the list of coordinate system, a determination may be made whether to select a coordinate system from the list of coordinate systems (block 205). For instance, the client may determine that the list is too extensive or coordinate systems in the list are incorrect.

If the client determines not to select a coordinate system, then the client may further specify attributes (block 201). Specifically, the client may be directed to a portion of the user interface that allows the client to add and/or remove attributes. Thus, using the portion of the user interface, the client may add attributes and/or remove attributes. Further, in one or more embodiments, the user interface allows the client to view the attributes that are extracted from document(s) and project metadata. In such embodiments, the client may remove attributes from the extracted attributes or add additional attributes.

In one or more embodiments, if the client has performed multiple iterations of specifying attributes and receiving a list of coordinate systems, the client may revert to a previous iteration using the log. Specifically, the client may revert to a previously specified set of attributes and list of coordinate systems using the log. For instance, the client may review the log of the client's actions and/or the log of which attributes removed particular coordinate systems from the list. After reviewing the log, the client may determine that a previous iteration is more indicative of the requirements of the client. In such a scenario, the client may request to use the attributes of the previous iteration.

After the client selects different attributes, the client may view a new list of coordinate systems (not shown). The new list may be in a different order and have more or fewer coordinate systems as the previous list. For instance, if the client adds attributes, fewer coordinate systems may be deemed appropriate and the coordinate systems in the list may be ordered differently from the previous list.

If the client determines to select a coordinate system (block 205), then the client selects the coordinate system from the list of coordinate systems (block 207). In one or more embodiments, since the coordinate systems are ranked in order of the most appropriate coordinate system, choosing the coordinate system may be selecting the highest ranking coordinate system from the list. Alternatively, the client may determine to select a different coordinate system from the list based on additional requirements for the coordinate system.

Optionally, a default coordinate system may be selected based on the rankings of the coordinate systems in the list. In this case, a map of the region may be generated in the default coordinate system for viewing by the client.

At this stage, a determination is made whether to view a map in the selected coordinate system (block 208). The determination of whether to view a map of the region may be dependent on the reason the client identified the coordinate system. For instance, if the client has spatial data of which the client previously did not know the coordinate system, then the client may simply create and store a metadata file to associate with the spatial data in the selected coordinate system. In such a scenario, the client may not want to view a map. Alternatively, the client may view the map of the spatial data to obtain a visual image of the spatial data in the selected coordinate system.

If a determination is made to view the map in the selected coordinate system (block 208), then a map of the region is generated in the coordinate system. Accordingly, the client views a map of the region (block 209).

In one or more embodiments, a determination is made whether to select a different coordinate system (block 211). For instance, after viewing the spatial data in a map, the client may determine that the coordinate system is not the correct coordinate system to associate with the spatial data. In another instance, the client may decide to select a different coordinate system based on requirements to preserve area, shape, direction, distance, and scale. In another instance, the client may decide to select a different coordinate system based on the aesthetics of the map in the coordinate system or based on the intended audience of the map.

If the client determines to select a different coordinate system, then a determination is made whether to select a different attributes (block 213). If a determination is made to select different attributes, then the client further specifies attribute(s) (block 201). Specifying attributes may be performed, for instance, as discussed above. Additionally, the client may use the log to specify different attributes (as discussed above).

Alternatively, the client may determine not to select different attributes and instead select a coordinate system from the previous list of coordinate systems. In such a scenario, the client receives the list of coordinate systems (block 203). Thus, the client may select a different coordinate system from the list of coordinate systems. As shown above, the user interface and the coordinate system framework guides the client in selecting the appropriate coordinate system.

FIG. 3 shows a flowchart of a method for a coordinate system framework to identify a coordinate system in accordance with one or more embodiments. Initially, a request is received for a coordinate system (block 251). As discussed above, the client submits a request for coordinate system identification. The request may only specify a document or project name, a file containing spatial data, may or may not include attributes that are explicitly defined, and may or may not include a spatial entity. In one or more embodiments, a project name may be derived from the request. For instance, in one or more embodiments, the client may be associated with a single project. In this instance, the request from the client may be determined to be for the single project. Thus, because the request is from the client, the project metadata for the single project is obtained.

From the request, attributes are obtained (block 253). Specifically, if the request includes explicitly defined attributes, then the attributes from the request are obtained. Further, if the request includes a documents name, then the attributes are extracted from the document. In one or more embodiments, extracting the attributes may include parsing the document for words and phrases that may be an attribute. In one or more embodiments, parsing the document may include comparing words and phrases in the document with a common attribute list. Words and phrases in the document that match the common attribute list are extracted and added to the collection of attributes.

Similar to extracting attributes from a document, attributes may also be extracted from project metadata. Specifically, the project metadata may be parsed to extract keywords corresponding to attributes. Further, if the client specifies a file containing spatial data, then the spatial data in the spatial file may be accessed to identify the coordinate system for the spatial data.

Continuing with FIG. 3, in one or more embodiments, business rule(s) are identified based on the attributes (block 255). The business rule(s) may be indentified based on type(s) of attributes, which may be specified or derived from the request. For instance, the client may specify a language, such as German, using a dedicated field or by using a keyword. In this instance, a business rule that accepts language as input is identified.

Using the business rules, the information repositories are identified (block 257). Specifically, each business rule specifies an information repository. Thus, the information repositories may be accessed to identify coordinate system(s) (block 259). In one or more embodiments, accessing the information repository may be performed by sending a query to the information repository. Specifically, in one or more embodiments, information repository metadata for the information repository is accessed to generate the query. For instance, if the information repository metadata includes a template, then the attributes are used with the template to create a query that is sent to the information repository.

Accessing the information repositories may be performed in series. For instance, a first information repository may be accessed with a first set of attributes to identify a second set of attributes or a spatial entity for the region. The output of the first information repository (e.g., second set of attributes or spatial entity) may be used in a second information repository to identify another set of attributes, a spatial entity, or a coordinate system. Determining the series (i.e., the order of the information repositories) may be based on business rules. For instance, one business rule may specify that the output of the information repository is an attribute of a certain type. The next business rule that is identified in series is a business rule that accepts the certain type of attribute as input.

In one or more embodiments, the last information repository that is accessed in series is the information repository that correlates coordinate systems with extents. Specifically, the spatial entity is used to query the information repository. If the region specified by the spatial entity exceeds the boundary of an extent associated with a coordinate system, then a determination is made whether the coordinate system may be used. For instance, to show a particular region in a Universal Transverse Mercator (UTM) zone, the entire region must be in the UTM zone. In such a scenario, when the extent of the region denoted by the spatial entity exceeds the boundaries of a UTM zone, then a determination is made that the coordinate system for the UTM zone may not be used.

Alternatively, other coordinate systems, such as the state plane coordinate system may be used even when the spatial entities exceed the boundary of the extent. In such a scenario, the percentage of the region denoted by the spatial entity that exceeds the boundary is calculated. The percentage may be used to rank the coordinate system.

Thus, in one or more embodiments, the coordinate systems are ranked (block 261). Several factors may be used to rank the coordinate system. For instance, factors may include, but are not limited to, the percentage of the region that exceeds the boundaries of the extent for the coordinate system, the intended use of the map, whether the map is a map of a survey which is already in a coordinate system, and properties of the region that the user wants to preserve in the map (e.g., area, shape, direction, distance, and scale). After ranking the list of coordinate systems, the list of coordinate systems is displayed according to the ranking (block 263). In one or more embodiments, the user interface displays the list of coordinate systems such that the client may select from the list or may choose additional attributes for modifying the list.

Further, a log entry is generated (block 265). Generating the log entry includes storing in the log the list of attributes and/or the coordinate systems for the attributes. One skilled in the art will appreciate that a log entry may be generated and used at any stage of the coordinate system identification. For instance, the log entry may be generated for any block discussed in FIG. 3.

A determination is made whether a selection of the coordinate system is received (block 267). If a selection of a coordinate system is received, then a determination is made whether to display a map (block 269). If a determination is made to display a map, then the map is generated (block 271). Specifically, the map is generated in the selected coordinate system. Techniques known in the art may be used to generate the map. Once the map is generated, or while generating the map, the map is displayed (block 273). Specifically, the map is displayed on a display device for the user.

After generating a map or if a selection of a coordinate system is not received, then a determination is made whether additional attributes are received (block 275). If additional attributes are received, then business rules based on the additional attributes are identified (block 255). Accordingly, the process may repeat with the additional attributes.

In the following example, consider the scenario in which a client is aware of a survey about two hundred miles South of Houston, Tex., USA performed by an oilfield services company. However, the client does not know the name of the survey, the exact location of the survey, or any additional information. In such a scenario, the client submits the name of the oilfield services company that generated the survey, the location of the survey (e.g., two hundred miles south of Houston), and that the client is looking for a particular survey.

Continuing with the example, the coordinate system framework accesses business rules to identify an information repository that stores a map of all surveys performed by the oilfield services company in response to the request. After accessing the first information repository and using the map, the coordinate system framework may determine from the map that there are eight different surveys performed by the oilfield services company two hundred miles south of Houston.

At this stage, the coordinate system framework may select a survey from the eight different surveys or may request that the client selects the survey. If the client selects a survey, then the coordinate system framework may display the names of the surveys in a list. After the survey is selected, than a business rule is used to identify how to obtain the survey and identify the coordinate system for the survey.

The business rule may specify a second information repository (e.g. the European Petroleum Survey Group (EPSG) database) to identify the coordinate system. Thus, the second information repository is accessed with the survey name. The second information repository may specify that the coordinate system has a projection ID of 26715 and is using a Transverse Mercator based on −93° longitude. At this stage, coordinate systems for the region (i.e., two hundred miles south of Houston) as well as the coordinate system for the survey may be displayed in a list for the client. Thus, the client may select a different coordinate system from the native coordinate system of the survey. For instance, the client may choose to select a different coordinate system that displays the survey in a projection that is familiar (e.g., displays Texas as a familiar shape).

Accordingly, the client selects the coordinate system and the map of the survey is displayed for the client.

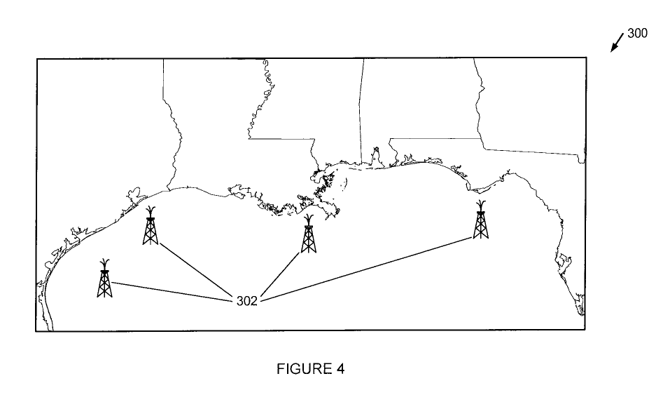

FIG. 4 shows a geographic display in accordance with one or more embodiments. More specifically, the geographic display shows a map (300) as described above with respect to FIGS. 1-3. Those skilled in the art will appreciate that the following example should not be construed as limiting the scope of coordinate system identification.

The map (300) depicts oilfield survey data for the Gulf of Mexico. More specifically, the map (300) depicts a number of platforms (302) located offshore in the Gulf of Mexico. Those skilled in the art will appreciate that the location of the platforms (302) within the map (300) may be modified based on a coordinate system selected by a client. For instance, the client may select a coordinate system for preserving distance properties of the map (300) to accurately measure distances between the platforms (302). In another instance, the client may select a different coordinate system for preserving area properties of the map (300) to accurately measure areas of the platforms (302), causing distance measurements between the platforms (302) to be less accurate.

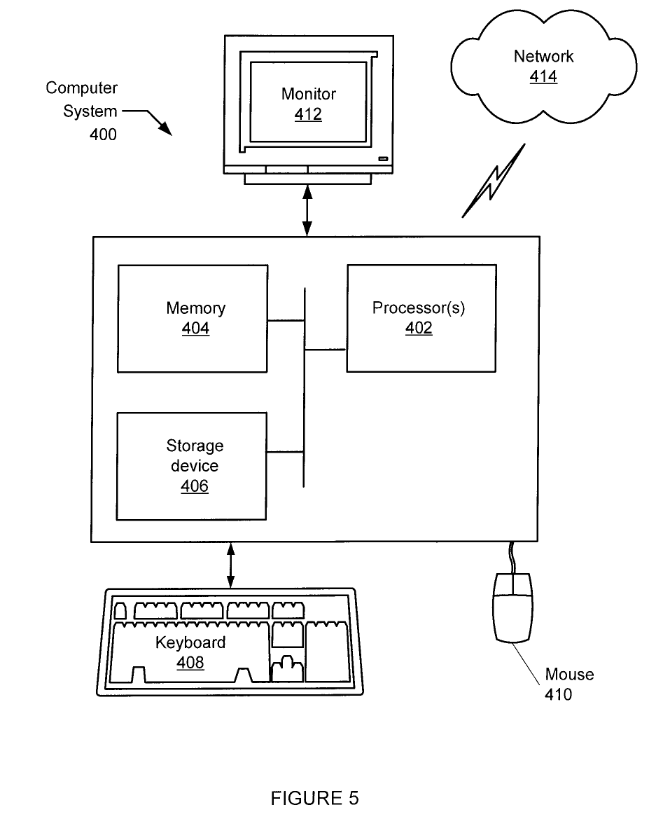

Embodiments of coordinate system identification may be implemented on virtually any type of computer regardless of the platform being used. For instance, as shown in FIG. 5, a computer system (400) includes a processor (402), associated memory (404) (e.g., random access memory (RAM), cache memory, flash memory, etc.), a storage device (406) (e.g., a hard disk, an optical drive such as a compact disk drive or digital video disk (DVD) drive, a flash memory stick, etc.), and numerous other elements and functionalities typical of today's computers (not shown). The computer (400) may also include input means, such as a keyboard (408) and a mouse (410), and output means, such as a monitor (412). The computer system (400) may be connected to a network (414) (e.g., a local area network (LAN), a wide area network (WAN) such as the Internet, or any other similar type of network) via a network interface connection (not shown). Those skilled in the art will appreciate that many different types of computer systems (400) exist (e.g., desktop computer, a laptop computer, a personal media device, a mobile device, such as a cell phone or personal digital assistant, or any other computing system capable of executing computer readable instructions), and the aforementioned input and output means may take other forms.

Further, those skilled in the art will appreciate that one or more elements of the aforementioned computer system (400) may be located at a remote location and connected to the other elements over a network. Further, coordinate system identification may be implemented on a distributed system having a plurality of nodes, where each portion (e.g., analyzer, business rules) may be located on a different node within the distributed system. In one or more embodiments, the node corresponds to a computer system. Alternatively, the node may correspond to a processor with associated physical memory. The node may alternatively correspond to a processor with shared memory and/or resources. Further, software instructions to perform embodiments of coordinate system identification may be stored on a computer readable medium such as a compact disc (CD), a diskette, a tape, a file, or any other computer readable storage device.

While coordinate system identification has been described with respect to a limited number of embodiments, those skilled in the art, having benefit of this disclosure, will appreciate that other embodiments can be devised which do not depart from the scope of coordinate system identification as disclosed herein. Accordingly, the scope should be limited only by the attached claims.

What is claimed is:

1. A method for coordinate system identification comprising:
obtaining a first attribute and a spatial entity of a region;
identifying a first plurality of information repositories using a business rule, the business rule identified using the first attribute;
accessing the first plurality of information repositories to identify a plurality of coordinate systems, each of the plurality of coordinate systems defined for the spatial entity;
selecting one of the plurality of coordinate systems;
transforming spatial data for the region based on the one of the plurality of coordinate systems to generate a first map; and
displaying the first map comprising the spatial data.

2. The method of claim 1, wherein the first attribute is obtained in a request from a client, wherein the request specifies one selected from a group consisting of a projected coordinate system and a geographic coordinate system.

3. The method of claim 1, wherein obtaining the first attribute comprises:
receiving a document name from a client, and
parsing the document to extract the first attribute.

4. The method of claim 1, wherein obtaining the first attribute comprises:
receiving identification of a project,
accessing project metadata for the project, and
extracting the first attribute from the project metadata.

5. The method of claim 1, wherein accessing the first plurality of information repositories comprises:
accessing a first information repository of the first plurality of information repositories using the first attribute to identify the spatial entity, and
accessing a second information repository of the first plurality of information repositories to identify the plurality of coordinate systems.

6. The method of claim 5, wherein accessing the first information repository comprises:
querying the first information repository with the first attribute to obtain a second attribute, and
querying a third information repository with the second attribute to identify the spatial entity.

7. The method of claim 1, further comprising:
generating a log of accessing the first plurality of information repositories.

8. The method of claim 1, wherein the first attributes specifies oilfield operations.

9. A computer readable medium, embodying instructions executable by a computer to perform a method for coordinate system identification, the instructions comprising functionality for:
obtaining a first attribute and a spatial entity of a region;
identifying a first plurality of information repositories using a business rule, the business rule identified using the first attribute;
accessing the first plurality of information repositories to identify a plurality of coordinate systems, each of the plurality of coordinate systems defined for the spatial entity; and
displaying an identifier for each of the plurality of coordinate systems.

10. The computer readable medium of claim 9, wherein obtaining the first attribute comprises:
receiving a document name from a client, and
parsing the document to extract the first attribute.

11. The computer readable medium of claim 9, wherein obtaining the first attribute comprises:
receiving identification of a project,
accessing project metadata for the project, and
extracting the first attribute from the project metadata.

12. The computer readable medium of claim 9, wherein accessing the first plurality of information repositories comprises:
accessing a first information repository of the first plurality of information repositories using the first attribute to identify the spatial entity, and
accessing a second information repository of the first plurality of information repositories to identify the plurality of coordinate systems.

13. The computer readable medium of claim 12, wherein accessing the first information repository comprises:
querying the first information repository with the first attribute,
receiving a second attribute as a result of the query, and
querying a third information repository with the second attribute to identify the spatial entity.

14. The computer readable medium of claim 9, further comprising computer readable program code embodied therein for causing a computer system to:
receive a request for a subset of the plurality of coordinate systems, wherein the request comprises a second attribute;
access a second plurality of information repositories using the second attribute to identify the subset of the plurality of coordinate systems; and
display an identifier for each coordinate system in the subset of the plurality of coordinate systems.

15. The computer readable medium of claim 14, further comprising computer readable program code embodied therein for causing a computer system to:
receive a first selection of a first coordinate system from the subset of the plurality of coordinate systems;
generate a first map of the region in the first coordinate system; and
display the first map.

16. The computer readable medium of claim 9, further comprising computer readable program code embodied therein for causing a computer system to:
generate a log of accessing the first plurality of information repositories.

17. A system for creating a first map comprising:
a user interface configured to:
receive a request, wherein a first attribute and a spatial entity are obtained based on the request,
display an identifier for each of a plurality of coordinate systems,
receive a first selection of a first coordinate system from the plurality of coordinate systems, and
display the first map; and
a coordinate system analyzer connected to the user interface and configured to:
identify a first plurality of information repositories using a business rule, the business rule identified using the first attribute,
access the first plurality of information repositories to identify the plurality of coordinate systems, each of the plurality of coordinate systems defined for the spatial entity, and
generate the first map of the region in the first coordinate system.

18. The system of claim 17, wherein the coordinate system analyzer comprises a document analyzer, wherein the document analyzer is configured to:
obtain a document based on a document name, wherein the document name is defined in the request, and
parse a document to extract the first attribute.

19. The system of claim 17, wherein the coordinate system analyzer comprises a document analyzer, wherein the document analyzer is configured to:
obtain project metadata for a project based on a project name, wherein the project name is defined as part of the request,
access project metadata for the project, and
extract the first attribute from the project metadata.

20. The system of claim 17, wherein accessing the first plurality of information repositories comprises:
accessing a first information repository of the first plurality of information repositories using the first attribute to identify the spatial entity, and
accessing a second information repository of the first plurality of information repositories to identify the plurality of coordinate systems.
